(19) United States
(12) Patent Application Publication
(10) Pub. No.: US 2025/0286635 A1
(43) Pub. Date: Sep. 11, 2025

(54) MEASUREMENT METHOD AND APPARATUS, AND DEVICE

(71) Applicant: VIVO MOBILE COMMUNICATION CO., LTD., Guangdong (CN)

(72) Inventors: Jian YAO, Guangdong (CN); Yannan YUAN, Guangdong (CN)

(73) Assignee: VIVO MOBILE COMMUNICATION CO., LTD., Guangdong (CN)

(21) Appl. No.: 19/218,680

(22) Filed: May 27, 2025

Related U.S. Application Data
(63) Continuation of application No. PCT/CN2023/133104, filed on Nov. 22, 2023.

(30) Foreign Application Priority Data
Nov. 28, 2022 (CN) 202211506196.2

(51) Int. Cl. H04B 17/20; H04B 17/345; H04B 17/364

(52) U.S. Cl. CPC H04B 17/252; H04B 17/345; H04B 17/364

(57) ABSTRACT

A measurement method and apparatus, and a device. The measurement method in embodiments of this application includes: receiving, by a first device, a first signal and a second signal, where a transmit direction of the first signal is a line-of-sight direction between a third device and the first device, a transmit direction of the second signal is a non-line-of-sight direction between the third device and the first device; performing, by the first device, measurement based on the first signal and the second signal, to obtain first information, where the first information indicates a measurement result of the first signal and a measurement result of the second signal, or indicates a difference between a measurement result of the first signal and a measurement result of the second signal; and sending, by the first device, the first information to a second device.

### CROSS-REFERENCE TO RELATED APPLICATIONS

This application is a continuation of International Application No. PCT/CN2023/133104 filed on Nov. 22, 2023, which claims priority to Chinese Patent Application No. 202211506196.2 filed on Nov. 28, 2022, which are incorporated herein by reference in their entireties.

### TECHNICAL FIELD

This application pertains to the field of communication technologies, and specifically, relates to a measurement method and apparatus, and a device.

### BACKGROUND

A future mobile communication system has a sensing capability in addition to a communication capability. The sensing capability means that one or more devices that have the sensing capability can sense information such as an orientation, a distance, and a velocity of a target object by sending and receiving a wireless signal, or detect, track, identify, and image a target object, an event, an environment, or the like.

A current sensing manner is that a transmit end sends a sensing signal, a receive end receives a signal reflected by the target object, and the receive end directly obtains a sensing result based on the received reflected signal. However, the reflected signal received by the receive end is affected by a communication environment, affecting accuracy of the sensing result.

### SUMMARY

According to a first aspect, a measurement method is provided. The method includes:
receiving, by a first device, a first signal and a second signal, where a transmit direction of the first signal is a line-of-sight direction between a third device and the first device, a transmit direction of the second signal is a non-line-of-sight direction between the third device and the first device, and the third device is a transmit end of the first signal and the second signal;
performing, by the first device, measurement based on the first signal and the second signal, to obtain first information, where the first information indicates a measurement result of the first signal and a measurement result of the second signal, or indicates a difference between a measurement result of the first signal and a measurement result of the second signal; and
sending, by the first device, the first information to a second device.

According to a second aspect, a measurement apparatus is provided, including:
a first receiving module, configured to receive a first signal and a second signal, where a transmit direction of the first signal is a line-of-sight direction between a third device and a first device, a transmit direction of the second signal is a non-line-of-sight direction between the third device and the first device, and the third device is a transmit end of the first signal and the second signal;
a first processing module, configured to perform measurement based on the first signal and the second signal, to obtain first information, where the first information indicates a measurement result of the first signal and a measurement result of the second signal, or indicates a difference between a measurement result of the first signal and a measurement result of the second signal; and
a first sending module, configured to send the first information to a second device.

According to a third aspect, a measurement method is provided, including:
receiving, by a second device, first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal; and
determining, by the second device, a sensing result based on the first information.

According to a fourth aspect, a measurement apparatus is provided, including:
a second receiving module, configured to receive first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal; and
a determining module, configured to determine a sensing result based on the first information.

According to a fifth aspect, a communication device is provided. The communication device includes a processor and a memory. The memory stores a program or instructions capable of being run on the processor, and when the program or the instructions are executed by the processor, the steps of the method according to the first aspect or the third aspect are implemented.

According to a sixth aspect, a communication device is provided, including a processor and a communication interface. The communication interface is configured to receive a first signal and a second signal, where a transmit direction of the first signal is a line-of-sight direction between a third device and a first device, a transmit direction of the second signal is a non-line-of-sight direction between the third device and the first device, and the third device is a transmit end of the first signal and the second signal. The processor is configured to perform measurement based on the first signal and the second signal, to obtain first information, where the first information indicates a measurement result of the first signal and a measurement result of the second signal, or indicates a difference between a measurement result of the first signal and a measurement result of the second signal. The communication interface is further configured to send the first information to a second device.

According to a seventh aspect, a communication device is provided, including a processor and a communication interface. The communication interface is configured to receive first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal.

The processor is configured to determine a sensing result based on the first information.

According to an eighth aspect, a measurement system is provided and includes a first device and a second device. The first device may be configured to perform the steps of the measurement method according to the first aspect, and the second device may be configured to perform the steps of the measurement method according to the third aspect.

According to a ninth aspect, a readable storage medium is provided. The readable storage medium stores a program or instructions, and when the program or the instructions are executed by a processor, the steps of the method according to the first aspect are implemented, or the steps of the method according to the third aspect are implemented.

According to a tenth aspect, a chip is provided. The chip includes a processor and a communication interface. The communication interface is coupled to the processor, and the processor is configured to run a program or instructions to implement the method according to the first aspect or implement the method according to the third aspect.

According to an eleventh aspect, a computer program/program product is provided. The computer program/program product is stored in a storage medium. The computer program/program product is executed by at least one processor to implement the steps of the method according to the first aspect or the method according to the third aspect.

### BRIEF DESCRIPTION OF DRAWINGS

FIG. 1 is a block diagram of a wireless communication system;

FIG. 2 is a schematic diagram of different sensing links of integrated sensing and communication;

FIG. 3 is a schematic diagram of sensing measurement by a bistatic radar;

FIG. 4 is a schematic flowchart 1 of a measurement method according to an embodiment of this application;

FIG. 5 is a schematic diagram of amplitude measurement of a target signal;

FIG. 6 is a schematic flowchart 2 of a measurement method according to an embodiment of this application;

FIG. 7 is a diagram 1 of a module structure of a measurement apparatus according to an embodiment of this application;

FIG. 8 is a diagram 2 of a module structure of a measurement apparatus according to an embodiment of this application;

FIG. 9 is a structural diagram of a communication device according to an embodiment of this application;

FIG. 10 is a structural diagram of a terminal according to an embodiment of this application;

FIG. 11 is a structural diagram 1 of a network-side device according to an embodiment of this application; and

FIG. 12 is a structural diagram 2 of a network-side device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specified order or sequence. It should be understood that terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” usually represents an “or” relationship between associated objects.

It should be noted that a technology described in the embodiments of this application is not limited to a long term evolution (LTE)/LTE-advanced (LTE-A) system, and may be further applied to other wireless communication systems, for example, a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. The technology described may be used for the systems and radio technologies described above, as well as other systems and radio technologies. A new radio (NR) system is described in the following descriptions for illustrative purposes, and NR terms are used in most of the following descriptions. However, these technologies may also be applied to applications such as a 6th generation (6G) communication system other than NR system applications.

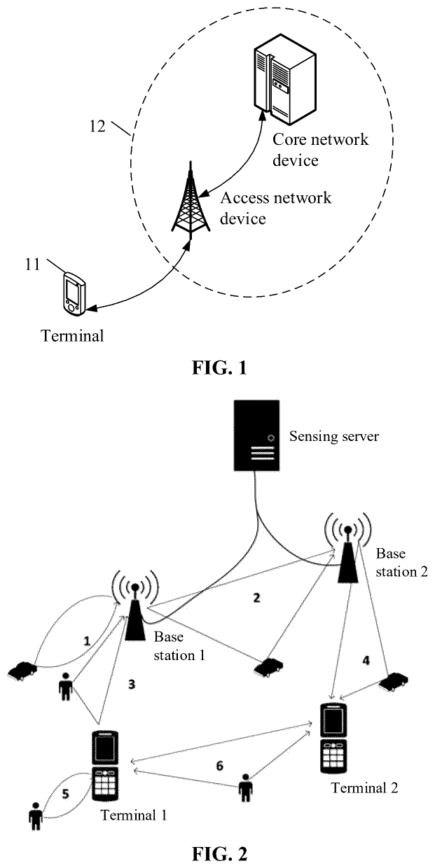

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer that is alternatively referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, for example, a refrigerator, a television, a laundry machine, or a piece of furniture), a gaming console, a personal computer (PC), a teller machine, a self-service machine, or another terminal-side device. The wearable device includes a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in the NR system is used as an example for description, and a specific type of the core network device is not limited.

For ease of understanding, the following describes some content related to the embodiments of this application.

### I. Integrated Sensing and Communication

A future mobile communication system such as a beyond 5th generation (B5G) system or a 6G system has a sensing capability in addition to a communication capability. The sensing capability means that one or more devices that have the sensing capability can sense information such as an orientation, a distance, and a velocity of a target object by sending and receiving a wireless signal, or detect, track, identify, and image a target object, an event, an environment, or the like. In the future, with the deployment of a small base station with a capability of a high frequency band and large bandwidth such as a millimeter wave and terahertz in a 6G network, resolution of sensing is significantly improved when compared with that of a centimeter wave, so that the 6G network can provide a more refined sensing service. Typical sensing functions and application scenarios are shown in Table 1.

TABLE 1

| Sensing function | Application scenario |
|---|---|
| Weather condition, air quality, and the like | Meteorology, agriculture, and life services |
| Traffic flow (intersections) and crowd flow | Intelligent traffic and commercial services |
| (subway entrances) | |
| Target tracking, ranging, velocity measurement, | Many application scenarios of a |
| outlining, and the like | conventional radar |
| Environment reconstruction | Intelligent driving and navigation |
| | (automobiles/unmanned aerial vehicles), |
| | smart city (3D maps), and network |
| | planning and network optimization |
| Action/posture/expression recognition | Smart interaction of smartphones, games, |
| | and smart home |
| Heartbeat/breathing and the like | Health and medical care |
| Imaging, material detection, component | Security inspection, industry, biological |
| analysis, and the like | medicine, and the like |

Integrated sensing and communication means that in a same system, a design of integrated communication and sensing functions is implemented through spectrum sharing and hardware sharing. When transferring information, the system can sense information such as an orientation, a distance, and a velocity, and detect, track, and identify a target device or an event. A communication system and a sensing system cooperate with each other, to improve overall performance and bring better service experience.

Integrated communication and radar is a typical application of integrated sensing and communication. In the past, a radar system and the communication system are strictly distinguished due to different research objects and focuses, and the two systems are independently studied in most scenarios. Actually, as typical manners of information sending, obtaining, processing, and exchange, the radar and communication systems share many similarities in terms of a working principle, a system architecture, and a frequency band. The design of integrated communication and radar is highly feasible, mainly embodied in the following aspects: First, both the communication system and the sensing system are based on an electromagnetic wave theory, and obtain and transfer information through transmission and reception of an electromagnetic wave. Second, both the communication system and the sensing system have structures such as an antenna, a transmit end, a receive end, and a signal processor, and hardware resources greatly overlap. With the development of technologies, operating frequency bands of the two systems increasingly overlap. In addition, there are similarities in key technologies such as signal modulation and reception detection and waveform design. Integration of the communication and radar systems can bring many advantages, for example, cost saving, size reduction, power consumption reduction, spectrum efficiency improvement, and mutual interference reduction, thereby improving overall system performance.

Based on different sensing signal sending nodes and receiving nodes, there are the following six types of sensing links, as shown in FIG. 2. It should be noted that for each type of sensing link in FIG. 2, one sending node and one receiving node are used as an example. In an actual system, different sensing links may be selected based on different sensing requirements. There may be one or more sending nodes and receiving nodes for each type of sensing link, and an actual sensing system may include a plurality of different sensing links. In FIG. 2, an example in which sensing objects are a human and a vehicle is used, and there are richer sensing objects in the actual system.
(1) Base station echo sensing: In this manner, a base station sends a sensing signal, and obtains a sensing result by receiving an echo of the sensing signal.
(2) Air interface sensing between base stations: In this case, a base station 2 receives a sensing signal sent by a base station 1, to obtain a sensing result.
(3) Uplink air interface sensing: In this case, a base station receives a sensing signal sent by a terminal (UE), to obtain a sensing result.
(4) Downlink air interface sensing: In this case, UE receives a sensing signal sent by a base station, to obtain a sensing result.
(5) Terminal echo sensing: In this case, UE sends a sensing signal, and obtains a sensing result by receiving an echo of the sensing signal.
(6) Sidelink sensing between terminals: For example, UE 2 receives a sensing signal sent by UE 1, to obtain a sensing result.

### II. Bistatic Radar

Radars may be classified into a monostatic radar and a bistatic/multistatic radar based on whether a transmitter and a receiver are separated. The bistatic radar usually requires a very long distance between a transmit antenna and a receive antenna, which is comparable to a radar range. An external radiation source radar is a special example of the bistatic radar, obtains, by using a related electromagnetic wave detection theory technology and a signal processing technology, a non-cooperative electromagnetic signal transmitted by a third party (for example, a communication base station), to detect, locate, track, and identify a target, and is also referred to as a passive radar, a bistatic/multistatic passive radar, a passive radar, a non-cooperative illuminator radar, or a non-cooperative passive detection system.

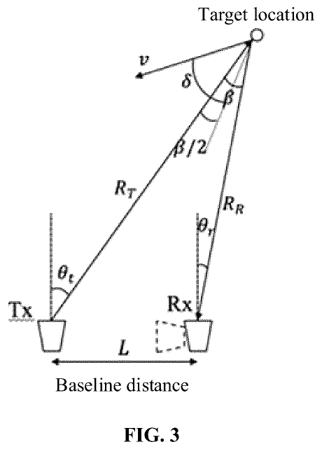

A sensing result of the bistatic radar usually needs to be calculated based on a reference channel (direct path) signal and a monitoring channel (reflected path) signal, as shown in FIG. 3. Distance and Doppler calculation is used as an example. A distance measured by the bistatic radar is (R_{T}30 R_{R})=2α=cΔτᵣₜ+L=cΔτₜ, that is, it is determined that a target location is a point on an ellipsoid, where c is a speed of light, Δυᵣₜ is a time difference between receiving the direct path signal and the target reflected path signal, Δτₜ is an absolute delay corresponding to a target reflected path (applicable to a case in which a transmit clock and a receive clock are synchronized), R_{T} is a distance between a transmit end and a target, L is a baseline distance, and θ_{R} is an observation angle at a receive end. A Doppler frequency shift of the bistatic radar that is caused due to movement of the target may be expressed as

$${f}_{d} = \frac{2 \vert v \vert}{λ} cos ( δ ) cos ( \frac{β}{2} ) = \frac{2 {f}_{c} \vert v \vert}{c} cos ( δ ) cos ( \frac{β}{2} ) = \frac{1}{λ} [ \frac{d}{dt} ( {R}_{T} + {R}_{R} ) ] = \frac{1}{λ} [ \vert v \vert cos ( δ - \frac{β}{2} ) + \vert v \vert cos ( δ + \frac{β}{2} ) ] ,$$

where

λ is a wavelength, ƒ_{c} is a center frequency, β is a bistatic angle, v is a moving velocity of the target object, δ is an angle between a moving direction of the target object and a bistatic bisector, and R_{R} is a distance between the target object and the receive end.

With reference to the accompanying drawings, the following describes, by using some embodiments and application scenarios thereof, in detail the measurement method provided in the embodiments of this application.

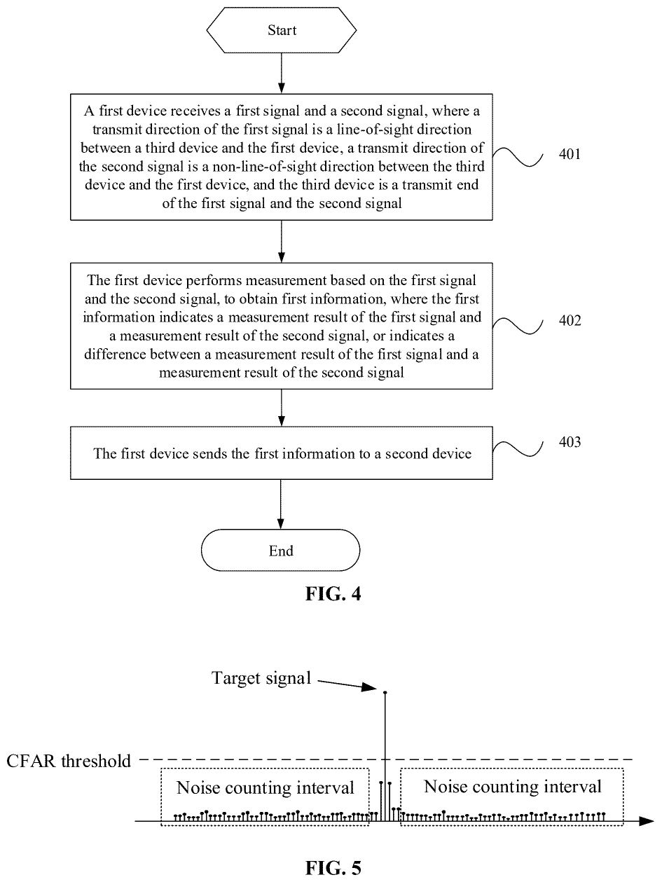

As shown in FIG. 4, a measurement method in an embodiment of this application includes the following steps.

Step 401: A first device receives a first signal and a second signal, where a transmit direction of the first signal is a line-of-sight direction between a third device and the first device, a transmit direction of the second signal is a non-line-of-sight direction between the third device and the first device, and the third device is a transmit end of the first signal and the second signal.

Herein, the third device sends the first signal in the LOS direction with the first device, and sends the second signal in the NLOS direction with the first device. The first device receives the first signal and the second signal, to perform subsequent steps.

Step 402: The first device performs measurement based on the first signal and the second signal, to obtain first information, where the first information indicates a measurement result of the first signal and a measurement result of the second signal, or indicates a difference between a measurement result of the first signal and a measurement result of the second signal.

That is, through measurement of the first signal and the second signal, the obtained first information can indicate the measurement result of the first signal and the measurement result of the second signal, or indicate the difference between the two measurement results. In this step, the first device performs measurement based on the first signal and the second signal received in step 401, to obtain the first information.

Step 403: The first device sends the first information to a second device.

In this step, the first device sends the first information obtained through measurement in step 402 to the second device.

In this way, based on steps 401 to 403, after receiving the first signal, whose transmit direction is the LOS direction, and the second signal, whose transmit direction is the NLOS direction, that are sent by the third device, the first device can perform measurement based on the first signal and the second signal, to obtain the first information, and send the first information to the second device, so that the second device can determine a sensing result based on the first information, thereby improving accuracy of the sensing result.

It should be noted that in this embodiment, the transmit direction may also be understood as a beam direction. In addition, the LOS direction between the third device and the first device is a direction toward the first device; and the NLOS direction between the third device and the first device is a direction toward a target sensing area.

In this embodiment, the measurement may be sensing measurement, a sensing target may be referred to as a target object, and there may be one or more target objects. In addition, the second device and the third device may be a same device, or may be different devices.

In this embodiment, the sensing result may be a location, a movement trajectory, status information, or the like of the target object.

Descriptions are provided with reference to a specific implementation scenario.

In downlink sensing, the first device is a terminal, and the second device is a base station or a sensing network function. For example, the terminal receives the first signal and the second signal sent by the base station, and performs measurement.

In uplink sensing, the first device is a base station, and the second device is a sensing network function. For example, the base station receives the first signal and the second signal sent by a terminal (the third device), and performs measurement.

In sensing between base stations, the first device is a base station A, and the second device is a base station B or a sensing network function. For example, the base station A receives the first signal and the second signal sent by the base station B, and performs measurement.

In sidelink sensing, the first device is a terminal A, and the second device is a terminal B, a base station, or a sensing network function. For example, the terminal A receives the first signal and the second signal sent by the terminal B, and performs measurement.

Herein, the sensing network function may also be referred to as a sensing network element or a sensing management function (Sensing MF), may be located on a RAN side or a core network side, is a network node responsible for at least one function such as sensing request processing, sensing resource scheduling, sensing information exchange, and sensing data processing in a core network and/or a RAN, and may be an upgrade based on an AMF or LMF in a 5G network, or may be another network node or a newly defined network node. Specifically, a function characteristic of the sensing network function may include at least one of the following:

Target information is exchanged with a wireless signal sending device and/or a wireless signal measurement device (including a target terminal, a serving base station of a target terminal, or a base station associated with a target area), where the target information includes a sensing processing request, a sensing capability, sensing auxiliary data, a sensing measurement quantity type, sensing resource configuration information, and the like, to obtain a target sensing result or a value of a sensing measurement quantity (an uplink measurement quantity or a downlink measurement quantity) sent by the wireless signal measurement device. The wireless signal may also be referred to as a sensing signal, for example, the first signal and the second signal.

A sensing method to be used is determined based on factors such as a type of a sensing service, sensing service consumer information, required sensing quality of service (QoS) requirement information, a sensing capability of the wireless signal sending device, and a sensing capability of the wireless signal measurement device. The sensing method may include: The base station A performs sending and the base station B performs receiving, the base station performs sending and the terminal performs receiving, the base station A independently performs sending and independently performs receiving, the terminal performs sending and the base station performs receiving, the terminal independently performs sending and independently performs receiving, the terminal A performs sending and the terminal B performs receiving, or the like.

A sensing device for serving the sensing service is determined based on factors such as the type of the sensing service, the sensing service consumer information, the required sensing QoS requirement information, the sensing capability of the wireless signal sending device, and the sensing capability of the wireless signal measurement device, where the sensing device includes the wireless signal sending device and/or the wireless signal measurement device.

Overall coordination and scheduling of resources required for the sensing service are managed. For example, sensing resources of the base station and/or the terminal are correspondingly configured.

Data processing is performed on the value of the sensing measurement quantity, or calculation is performed to obtain a sensing result. Further, the sensing result is verified, sensing accuracy is estimated, and so on.

Optionally, the first information is associated with at least one of the following:
delay information; distance information; Doppler information; velocity information; angle information; amplitude information; phase information; and spectrum information.

Optionally, the spectrum information includes at least one of a delay-Doppler spectrum, a range-velocity spectrum, a range-Doppler spectrum, a delay-Doppler-angle spectrum, a range-Doppler-angle spectrum, and a range-velocity-angle spectrum.

Optionally, the delay information includes at least one of the following:
a time of arrival of the first signal;
a time of arrival of the second signal; and
a time difference of arrival between the first signal and the second signal.

In an implementation, the time of arrival of the first signal may be a delay value of a strongest path/first-arrival path of the first signal or a delay value of at least one path whose path strength exceeds a preset path strength threshold in the first signal. The time of arrival of the second signal may be a delay value of a strongest path of the second signal or a delay value of at least one path whose path strength exceeds the preset path strength threshold in the second signal. The time difference of arrival between the first signal and the second signal may be a delay difference between the strongest path/first-arrival path of the first signal and the strongest path of the second signal or a delay difference between the strongest path/first-arrival path of the first signal and the at least one path whose path strength exceeds the preset path strength threshold in the second signal.

The distance information includes at least one of the following:
a first distance, where the first distance is a distance between the target object and the first device;
a second distance, where the second distance is a distance between the target object and the third device;
a third distance, where the third distance is a sum of the first distance and the second distance; and
a fourth distance, where the fourth distance is a difference between the third distance and a fifth distance, and the fifth distance is a distance between the first device and the third device.

Herein, the first distance may be further understood as a distance of the target object relative to the first device, and is denoted as RR; and the second distance may be further understood as a distance of the target object relative to the third device, and is denoted as RT. In this case, the third distance is R_{T}+R_{R}, and the fourth distance is R_{T}+R_{R}−L, where L is a distance between the first device and the third device.

Optionally, the Doppler information includes at least one of the following:
a Doppler frequency shift of the first signal;
a Doppler frequency shift of the second signal; and
a Doppler frequency shift difference between the first signal and the second signal.

In an implementation, the Doppler frequency shift of the first signal may be a Doppler frequency shift of the strongest path/first-arrival path of the first signal or a Doppler frequency shift of the at least one path whose path strength exceeds the preset path strength threshold in the first signal. The Doppler frequency shift of the second signal may be a Doppler frequency shift of the strongest path of the second signal or a Doppler frequency shift of the at least one path whose path strength exceeds the preset path strength threshold in the second signal. The Doppler frequency shift difference between the first signal and the second signal may be a Doppler frequency shift difference between the strongest path/first-arrival path of the first signal and the strongest path of the second signal or a Doppler frequency shift difference between the strongest path/first-arrival path of the first signal and the at least one path whose path strength exceeds the preset path strength threshold in the second signal.

Optionally, the velocity information includes at least one of the following:
a moving velocity of the target object; and
a component of the moving velocity of the target object.

Herein, the moving velocity of the target object is an original moving velocity of the target object, for example, an original moving velocity v in a global coordinate system. The component of the moving velocity of the target object is a projection component of the original moving velocity of the target object in a specific direction, for example, a radial velocity v*cos (δ+β/2) relative to the first device or a velocity component v*cos δ along a bistatic bisector.

Optionally, the angle information includes at least one of the following:
an angle of arrival of the first signal;
an angle of arrival of the second signal;
an angle difference of arrival between the first signal and the second signal; and
a bistatic angle.

Herein, the angle of arrival of the second signal is an angle of the target object relative to the first device, and is denoted as Or.

Optionally, the amplitude information includes at least one of the following:
an amplitude of the first signal;
an amplitude of the second signal; and
an amplitude difference between the first signal and the second signal.

In an implementation, the amplitude of the first signal may be an amplitude of the strongest path/first-arrival path of the first signal or an amplitude of the at least one path whose path strength exceeds the preset path strength threshold in the first signal. The amplitude of the second signal may be an amplitude of the strongest path of the second signal or an amplitude of the at least one path whose path strength exceeds the preset path strength threshold in the second signal. The amplitude difference between the first signal and the second signal may be an amplitude difference between the strongest path/first-arrival path of the first signal and the strongest path of the second signal or an amplitude difference between the strongest path/first-arrival path of the first signal and the at least one path whose path strength exceeds the preset path strength threshold in the second signal.

Optionally, the phase information includes at least one of the following:
a phase of the first signal;
a phase of the second signal; and
a phase difference between the first signal and the second signal.

In an implementation, the phase of the first signal may be a phase of the strongest path/first-arrival path of the first signal or a phase of the at least one path whose path strength exceeds the preset path strength threshold in the first signal. The phase of the second signal may be a phase of the strongest path of the second signal or a phase of the at least one path whose path strength exceeds the preset path strength threshold in the second signal. The phase difference between the first signal and the second signal may be a phase difference between the strongest path/first-arrival path of the first signal and the strongest path of the second signal or a phase difference between the strongest path/first-arrival path of the first signal and the at least one path whose path strength exceeds the preset path strength threshold in the second signal.

In this embodiment, optionally, the first information further includes performance indicator information, and the performance indicator information is used to adjust a sending configuration of the first signal and/or a sending configuration of the second signal.

That is, after receiving the first information including the performance indicator information, the second device can adjust the sending configuration of the first signal and/or the sending configuration of the second signal by using the performance indicator information. For example, when one or more performance indicators do not meet a requirement, transmit power is increased, time-frequency domain resource density is increased, and so on.

Optionally, the performance indicator information includes at least one of the following:
a signal-to-noise ratio (SNR) of the first signal;
a signal-to-interference-plus-noise ratio (SINR) of the first signal;
an SNR of the second signal;
an SINR of the second signal;
an SNR obtained based on the SNR of the first signal and the SNR of the second signal;
an SINR obtained based on the SINR of the first signal and the SINR of the second signal;
power of a signal component associated with the target object;
an SNR of the signal component associated with the target object;
an SINR of the signal component associated with the target object;
a strength indicator of the first signal;
received power of the first signal;
received quality of the first signal;
a strength indicator of the second signal;
received power of the second signal; and
received quality of the second signal.

That is, the performance indicator information includes one or more of the foregoing performance indicators.

In an implementation, the SNR (a first SNR) of the first signal is a ratio of a linear average value of signal power corresponding to a time-frequency resource carrying the first signal to a linear average value of noise power corresponding to the same time-frequency resource; the SINR (a first SINR) of the first signal is a ratio of the linear average value of the signal power corresponding to the time-frequency resource carrying the first signal to a linear average value of noise and interference power corresponding to the same time-frequency resource; the SNR (a second SNR) of the second signal is a ratio of a linear average value of signal power corresponding to a time-frequency resource carrying the second signal to a linear average value of noise power corresponding to the same time-frequency resource; and the SINR (a second SINR) of the second signal is a ratio of the linear average value of the signal power corresponding to the time-frequency resource carrying the second signal to a linear average value of noise and interference power corresponding to the same time-frequency resource.

The SNR (a third SNR) obtained based on the SNR of the first signal and the SNR of the second signal may be calculated by performing weighted combination on the SNR of the first signal and the SNR of the second signal, or may be calculated based on a formula SNR3=(SNR1*SNR*(B*T−1))/((SNR1+1)*(SNR2+1))+1, where SNR1 is the first SNR, SNR2 is the second SNR, SNR3 is the third SNR, B is a frequency domain resource length of the first signal/second signal, and T is a time domain resource length of the first signal/second signal.

The SINR (a third SINR) obtained based on the SINR of the first signal and the SINR of the second signal may be calculated by performing weighted combination on the SINR of the first signal and the SINR of the second signal.

The power of the signal component associated with the target object may be a power value of a sensing path.

It should be noted that the power of the signal component associated with the target object is power of a signal component that is in a received target signal and that is relatively greatly affected by the sensing target, and may be a power value calculated by using an amplitude corresponding to a sample value point with a largest amplitude in a Fourier transform (FFT)/inverse Fourier transform (IFFT) result (Doppler domain, delay domain, or angle domain information) of the target signal in at least one dimension (at least one of a time dimension, a frequency dimension, and an antenna dimension) as a target amplitude, or a power value calculated by using amplitudes corresponding to a plurality of sample value points with largest amplitudes as a target amplitude; or a power value calculated by using an amplitude corresponding to a sample value point with a largest amplitude in a specific range in the FFT/IFFT result (the Doppler domain, delay domain, or angle domain information) as a target amplitude, or a power value calculated by using amplitudes corresponding to a plurality of sample value points with largest amplitudes as a target amplitude.

It should be noted that the largest amplitude may be an amplitude exceeding a specific threshold. The specific threshold may be indicated by a network-side device, or may be calculated by the terminal based on noise and/or interference power. The specific delay/Doppler/angle range is related to a sensing requirement, and may be indicated by the network-side device, or may be obtained by the terminal based on the sensing requirement.

Radar detection is used as an example. A method for obtaining the power of the signal component associated with the target object may be at least one of the following options:

Constant false-alarm rate (CFAR) is performed based on a one-dimensional delay map obtained through fast-time dimension (FFT) processing of the target signal, a sample value point with a largest amplitude whose CFAR exceeds a threshold is used as a target sample value point, and an amplitude of the target sample value point is used as a target signal amplitude.

CFAR is performed based on a one-dimensional Doppler map obtained through slow-time dimension FFT processing of the target signal, a sample value point with a largest amplitude whose CFAR exceeds a threshold is used as a target sample value point, and an amplitude of the target sample value point is used as a target signal amplitude, as shown in FIG. 5.

CFAR is performed based on a two-dimensional delay-Doppler map obtained through 2D-FFT processing of the target signal, a sample value point with a largest amplitude whose CFAR exceeds a threshold is used as a target sample value point, and an amplitude of the target sample value point is used as a target signal amplitude.

CFAR is performed based on a three-dimensional delay-Doppler-angle map obtained through 3D-FFT processing of the target signal, a sample value point with a largest amplitude whose CFAR exceeds a threshold is used as a target sample value point, and an amplitude of the target sample value point is used as a target signal amplitude.

It should be noted that in addition to using the sample value point with the largest amplitude whose CFAR exceeds the threshold as the target sample value point, a method for determining the target signal amplitude may be using an average value of the sample value point with the largest amplitude whose CFAR exceeds the threshold and several nearest sample value points exceeding the threshold as the target signal amplitude.

The SNR of the signal component associated with the target object may be a ratio of the power of the signal component associated with the target object to noise power. The SINR of the signal component associated with the target object may be a ratio of a power value of the signal component associated with the target object and a sum of noise and interference power.

In an implementation, a method for obtaining the SNR of the signal component associated with the target object or the SINR of the signal component associated with the target object may be at least one of the following options:

Constant false-alarm rate (CFAR) is performed based on a one-dimensional delay map obtained through fast-time dimension FFT processing of the target signal, a sample value point with a largest amplitude whose CFAR exceeds a threshold is used as a target sample value point, an amplitude of the target sample value point is used as a target signal amplitude, all sample value points different from those +& sample value points away from a location of the target sample value point in the one-dimensional map are used as interference/noise sample value points, and an average interference/amplitude of the interference/noise sample value points is counted as an interference/noise signal amplitude. Finally, calculation is performed by using the target signal amplitude and the interference/noise signal amplitude.

CFAR is performed based on a one-dimensional Doppler map obtained through slow-time dimension FFT processing of the target signal, a sample value point with a largest amplitude whose CFAR exceeds a threshold is used as a target sample value point, an amplitude of the target sample value point is used as a target signal amplitude, all sample value points different from those ±η sample value points away from a location of the target sample value point in the one-dimensional map are used as interference/noise sample value points, and an average amplitude of the interference/noise sample value points is counted as an interference/noise signal amplitude.

Finally, calculation is performed by using the target signal amplitude and the interference/noise signal amplitude.

CFAR is performed based on a two-dimensional delay-Doppler map obtained through 2D-FFT processing of the target signal, a sample value point with a largest amplitude whose CFAR exceeds a threshold is used as a target sample value point, an amplitude of the target sample value point is used as a target signal amplitude, all sample value points different from those ±ε (a fast-time dimension) and ±η (a slow-time dimension) sample value points away from the target sample value point in the two-dimensional map are used as interference/noise sample value points, and an average amplitude of the interference/noise sample value points is counted as an interference/noise signal amplitude. Finally, calculation is performed by using the target signal amplitude and the interference/noise signal amplitude.

CFAR is performed based on a three-dimensional delay-Doppler-angle map obtained through 3D-FFT processing of the target signal, a sample value point with a largest amplitude whose CFAR exceeds a threshold is used as a target sample value point, an amplitude of the target sample value point is used as a target signal amplitude, all sample value points different from those ±ε (a fast-time dimension), ±η (a slow-time dimension), and ±δ (an angle dimension) sample value points away from the target sample value point in the three-dimensional map are used as interference/noise sample value points, and an average amplitude of the interference/noise sample value points is counted as an interference/noise signal amplitude. Finally, calculation is performed by using the target signal amplitude and the interference/noise signal amplitude.

It should be noted that in addition to using the sample value point with the largest amplitude whose CFAR exceeds the threshold as the target sample value point, a manner of determining the target signal amplitude may be using an average value of the sample value point with the largest amplitude whose CFAR exceeds the threshold and several nearest sample value points exceeding the threshold as the target signal amplitude.

It should be noted that a manner of determining the interference/noise sample value point may alternatively be performing further screening based on the determined interference/noise sample value point. A screening manner is as follows: For the one-dimensional delay map, several sample value points near a delay of 0 are removed, and remaining interference/noise sample value points are used as noise sample value points; for the one-dimensional Doppler map, several sample value points near Doppler of 0 are removed, and remaining interference/noise sample value points are used as interference/noise sample value points; for the two-dimensional delay-Doppler map, several points near a delay of 0 and interference/noise sample value points in a strip range formed by all Doppler ranges are removed, and remaining noise sample value points are used as interference/noise sample value points; or for the three-dimensional delay-Doppler-angle map, several points near a time dimension of 0 and interference/noise sample value points in a slice range formed by all Doppler ranges and all angle ranges are removed, and remaining interference/noise sample value points are used as interference/noise sample value points.

In addition, in this embodiment, optionally, the first signal or the second signal includes at least one of the following:
a reference signal;
a synchronization signal;
a sensing signal; and
a signal that carries communication data information.

In an implementation, the reference signal is a communication reference signal, for example, a channel state information-reference signal (CSI-RS) or a physical downlink shared channel (PDSCH) demodulation reference signal (DMRS). The synchronization signal is, for example, a primary synchronization signal (PSS) or a secondary synchronization signal (SSS). The sensing signal is a signal designed specifically for sensing measurement, for example, a sensing signal designed based on a Gold sequence or a ZC sequence or a sensing signal designed based on a frequency modulated continuous wave (FMCW). The signal that carries communication data information is a signal for transmitting the communication data information such as first data.

Optionally, the method further includes:

The first device obtains configuration information of the first signal and/or configuration information of the second signal before receiving the first signal and the second signal, where the configuration information includes at least one of the following:
a signal resource identifier;
waveform information;
a subcarrier spacing;
a guard interval;
frequency domain resource information;
time domain resource information;
signal power;
sequence information; and
a signal direction.

That is, before receiving the first signal and the second signal and performing measurement, the first device can obtain the configuration information of the first signal and/or the configuration information of the second signal, so that the first signal or the second signal can be accurately received based on the configuration information, to perform subsequent measurement.

In an implementation, the configuration information of the first signal and/or the configuration information of the second signal are/is sent by the second device or sent by the third device.

The signal resource identifier (ID) is used to distinguish between different signal resource configurations. The first device determines, by using the signal resource ID in the configuration information of the first signal and/or the configuration information of the second signal, a signal resource used by the first signal and/or a signal resource used by the second signal.

The waveform information may be orthogonal frequency division multiplex (OFDM), single-carrier frequency-division multiple access (SC-FDMA), orthogonal time frequency space (OTFS), a frequency modulated continuous wave (FMCW), a pulse signal, or the like.

The subcarrier spacing may correspond to a configuration of 30 kHz of an OFDM system.

The guard interval is a time interval between a moment at which sending of a signal is ended and a moment at which a latest echo signal of the signal is received, and is directly proportional to a maximum sensing distance. For example, calculation may be performed by using c/(2Rₘₐₓ). Herein, Rₘₐₓ is the maximum sensing distance (which is sensing requirement information). For example, for an independently sent and independently received sensing signal, Rₘₐₓ represents a maximum distance between a sensing signal transmit/receive point and a signal transmit point. In some cases, a cyclic prefix (CP) of an OFDM signal may serve as a minimum guard interval. Herein, c is a speed of light.

The frequency domain resource information includes at least one of the following: a frequency domain start location, a frequency domain resource length, and a frequency domain resource interval. Herein, the frequency domain start location may be a start frequency, or may be a start RE or RB index. The frequency domain resource length is frequency domain bandwidth, the frequency domain bandwidth is inversely proportional to range resolution, and frequency domain bandwidth of each first signal is B≥c/(2ΔR), where c is a speed of light, and AR is the range resolution. The frequency domain resource interval is inversely proportional to a maximum unambiguous range/delay. For an OFDM system, the frequency domain interval is equal to the subcarrier spacing when subcarriers are continuously mapped.

The time domain resource information includes at least one of the following: a time domain start location, a time domain resource length, and a time domain resource interval. Herein, the time domain start location may be a start time point, or may be a start symbol, slot, or frame index. The time domain resource length is also referred to as burst duration, and is inversely proportional to Doppler resolution. The time domain resource interval is a time interval between two adjacent signals, and the time domain resource interval is associated with a maximum unambiguous Doppler frequency shift or a maximum unambiguous velocity.

The signal direction may be understood as angle information or beam information for signal sending.

The sequence information may include used generation sequence information (for example, a ZC sequence or a PN sequence) and a generation manner.

The signal power may be a value taken at an interval of 2 dBm from-20 dBm to 23 dBm.

Optionally, the first signal and the second signal meet at least one of the following:
a same time domain resource length;
a same time domain resource interval;
a same frequency domain resource length; and
a same frequency domain resource interval.

It should be noted that for the second signal, the time domain resource length is associated with Doppler/velocity resolution, the time domain resource interval is associated with a maximum unambiguous Doppler/velocity, the frequency domain resource length is associated with delay/range resolution, and the frequency domain resource interval is associated with a maximum unambiguous delay/range. The Doppler/velocity, the delay/range resolution, the maximum unambiguous Doppler/velocity, the maximum unambiguous delay/range, and the like may be from the sensing requirement, and the sensing requirement may be from the sensing network function. For example, the sensing network function sends the sensing requirement to the second device.

Optionally, the first signal and the second signal are frequency division multiplexing signals, time division multiplexing signals, or code division multiplexing signals.

That is, the first signal and the second signal are frequency division multiplexing signals, the first signal and the second signal are time division multiplexing signals, or the first signal and the second signal are code division multiplexing signals.

In this embodiment, optionally, the method further includes:

The first device obtains measurement indication information before performing measurement, where the measurement indication information includes at least one of the following:
a measurement signal indication;
a measurement quantity;
a reporting configuration; and
measurement auxiliary information.

That is, before receiving the first signal and the second signal for measurement, the first device obtains the measurement indication information, so that the first device subsequently performs measurement and reporting based on the measurement indication information, to ensure that the second device can finally obtain the required first information, and then obtain a final sensing result. The measurement indication information is used to indicate the first device to perform measurement and reporting.

In an implementation, the measurement indication information is sent by the second device.

The configuration information of the first signal and/or the configuration information of the second signal and the measurement indication information may be sent by using same signaling, for example, the measurement indication information and the configuration information of the first signal are sent together; or may be sent by using different signaling, and a sequence of the two is not limited.

The measurement signal indication is used to indicate a signal based on which the first device performs sensing measurement. The measurement signal indication includes at least one of the following: an identifier of the first signal and an identifier of the second signal. Herein, the identifier of the signal may be a signal resource ID or a port number, or may directly indicate a specific time-frequency domain resource of the signal.

The measurement quantity corresponds to a measurement result (the measurement result is a value of the measurement quantity), that is, at least one of a delay, a distance, Doppler, a velocity, an angle, an amplitude, a phase, and the performance indicator information in the first information.

The reporting configuration is a criterion for reporting the first information, and includes at least one of a time-frequency domain resource configuration for reporting, a reporting period, and a trigger condition for reporting.

The measurement auxiliary information includes at least one of the following: a location of a sending device (which may be the second device) of the first signal/second signal, a distance (that is, a baseline distance L) between the sending device (which may be the second device) of the first signal/second signal and the first device, a sensing target area, and a receive beam indication (the first signal and the second signal may be received by using beams in different directions or received by using a same wide beam).

Optionally, the method further includes:

The first device sends second information before obtaining the measurement indication information, where the second information includes at least one of the following:
location information of the first device; and
channel state information of the first device and the third device.

Herein, the location information of the first device is used to determine the transmit direction of the first signal; and the channel state information of the first device and the third device is used to determine whether to select the first device as a sensing measurement device. In this way, the first device sends the second information, and when the second information is the location information of the first device, it is ensured that a signal transmit end can send a valid first signal; or when the second information is the channel state information of the first device and the third device, a first device suitable for performing measurement is selected, to ensure obtaining and quality of the first information.

In an implementation, the first device sends the second information to the second device, or certainly may send the second information to the third device.

The location information of the first device may be location coordinates, a distance, an angle, or the like relative to the sending device (which may be the second device) of the first signal/the second signal.

The channel state information of the first device and the third device (which may be the second device) includes whether there is a LOS link. In an implementation, a method for determining the LOS may be as follows: If a distance L between or locations of a transmit device and a receive device is or are known, it is determined, by using an RTT based on a measured delay and L, whether there is a LOS path.

In addition, in this embodiment, optionally, that the first device performs measurement based on the first signal and the second signal, to obtain first information includes:

The first device obtains first channel information based on the first signal;
the first device obtains second channel information based on the second signal; and
the first device obtains the first information based on the first channel information and the second channel information.

The first device may separately obtain, based on the first channel information, first information (for example, the time of arrival of the first signal) related to the first signal, obtain, based on the second channel information, first information (for example, the time of arrival of the second signal) related to the second signal, and then further calculate first information (for example, the time difference of arrival between the first signal and the second signal) related to both the first signal and the second signal. The first device may further obtain the first information based on a quotient or conjugate multiplication of the first channel information and the second channel information.

### Example 1

The first signal (reference channel signal) and the second signal (monitoring channel signal) are beamformed by using different beamforming vectors. The first signal is sent by using a beam pointing to a terminal direction, and the second signal is sent by using a beam pointing to the sensing area. After receiving the first signal and the second signal based on the configuration information of the first signal and the configuration information of the second signal, the terminal performs channel estimation to obtain channel response information H1 (the first channel information) and H2 (the second channel information), and further obtains the first information based on the channel information.

Herein, it is assumed that the first signal and the second signal correspond to time-frequency domain resources of N OFDM symbols and M subcarriers. In this case, matrix sizes of H1 and H2 are M*N (a row corresponds to time domain and a column corresponds to frequency domain). It is assumed that there is a single moving target in the target sensing area. In this case, reference channel delay domain information may be obtained by performing IFFT calculation in a frequency domain dimension based on H1 (a single OFDM symbol is used as an example), for example, the delay value of the strongest path/first-arrival path of the first signal is τ1=20.35 (ns); and reference channel delay domain information may be obtained by performing IFFT calculation in the frequency domain dimension based on H2 (a single OFDM symbol is used as an example), for example, the delay value of the strongest path of the second signal is τ2=315.4 (ns). In this case, the delay difference between the strongest path/first-arrival path of the first signal and the strongest path of the second signal is Δτ=295.05 (ns). It should be noted that the terminal may report a quantization result of actual delay information, or may report an index value corresponding to a path (a strongest path or a path whose strength exceeds the preset path strength threshold) that meets a condition after IFFT is performed in frequency domain.

Similarly, reference channel Doppler domain information may be obtained by performing DFT/FFT calculation in a time domain dimension based on H1 (a single subcarrier is used as an example), for example, the Doppler frequency shift value of the strongest path/first-arrival path of the first signal is 26.67 (Hz); and reference channel delay domain information may be obtained by performing IDFT/IFFT calculation in the frequency domain dimension based on H2 (a single subcarrier is used as an example), for example, the Doppler frequency shift value of the strongest path of the second signal is 315.4 (Hz). In this case, the Doppler frequency shift difference between the strongest path/first-arrival path of the first signal and the strongest path of the second signal is 288.73 (Hz). It should be noted that the terminal may report a quantization result of actual Doppler information, or may report an index value corresponding to a path (a strongest path or a path whose strength exceeds the preset path strength threshold) that meets a condition after DFT/FFT is performed in the time domain dimension.

Calculation of the angle information (a plurality of receive antennas) is similar. Based on channel information H1 and H2 of different antennas, the angle information may be obtained by performing a DFT/FFT operation in an antenna dimension or by performing calculation by using a super-resolution algorithm such as MUSIC. For example, the angle of arrival of the strongest path/first-arrival path of the first signal is 0.9°; and the angle of arrival of the strongest path of the second signal is 58.2°. In this case, the angle difference of arrival between the strongest path/first-arrival path of the first signal and the strongest path of the second signal is 57.3°. It may be understood that the angle information calculated herein is angle information in a local coordinate system of the receiver, and the angle information in the first information may be angle information in the local coordinate system, or may be converted into angle information in the global coordinate system.

Alternatively, delay-Doppler domain information may be obtained by performing a two-dimensional DFT/FFT operation based on H1 and H2, to obtain delay and Doppler measurement results in the first information. Alternatively, delay-Doppler-angle domain information is obtained by performing a three-dimensional DFT/FFT operation based on H1 and H2, to obtain delay, Doppler, and angle measurement results in the first information.

Further, the sum of the distance of the target object relative to the first device (receiver) and the distance relative to the third device (transmitter) minus the distance between the transmitter and the receiver may be calculated based on the delay information (the time difference of arrival Δτ between the first signal and the second signal): R_{T}+R_{R}−L=↑τ*c (c is a speed of light). The distance of the target object relative to the receiver may be calculated based on the delay and angle information:

$${R}_{R} = \frac{{( {R}_{T} + {R}_{R} )}^{2} - {L}^{2}}{2 ( {R}_{T} + {R}_{R} + L sin {θ}_{R} )} ,$$

where θr is an angle of the target object relative to the receiver.

If an angle of departure of the first signal and an angle of departure of the second signal are known, the bistatic angle β may be further calculated with reference to the angle of arrival of the first signal and the angle of arrival of the second signal. Based on the bistatic angle, the Doppler frequency shift, and a formula

$${f}_{d} = \frac{2 \vert v \vert}{λ} cos ( δ ) cos ( \frac{β}{2} ) = \frac{2 {f}_{c} \vert v \vert}{c} cos ( δ ) cos ( \frac{β}{2} ) = \frac{1}{λ} [ \frac{d}{dt} ( {R}_{T} + {R}_{R} ) ] = \frac{1}{λ} [ \vert v \vert cos ( δ - \frac{β}{2} ) + \vert v \vert cos ( δ + \frac{β}{2} ) ] ,$$

the velocity v*cos δ of the target object relative to the bistatic bisector may be calculated. Further, an actual moving velocity v of the target object may be further obtained based on prior information of a target moving direction or target moving direction information obtained through a plurality of times of measurement.

It should be noted that this example is provided for illustrative purposes, and a specific calculation method used is not limited.

### Example 2

The first signal (reference channel signal) and the second signal (monitoring channel signal) are beamformed by using different beamforming vectors. The first signal is sent by using a beam pointing to a terminal direction, and the second signal is sent by using a beam pointing to the sensing area. After receiving the first signal and the second signal based on the configuration information of the signal, the terminal performs channel estimation to obtain channel response information H1 (the first channel information) and H2 (the second channel information), calculates a quotient of H2 and Hl element by element in a time-frequency domain dimension, that is, H2·/H1 (or calculates a result of conjugate multiplication of H2 and H1, where each element in H1 is conjugated and then multiplied by H2 element by element), and performs calculation based on the quotient or conjugate multiplication of the channel response information, to obtain the first information.

It is assumed that the first signal and the second signal correspond to time-frequency domain resources of N OFDM symbols and M subcarriers. In this case, matrix sizes of H1, H2, and H2·/H1 are M*N (a row corresponds to time domain and a column corresponds to frequency domain). It is assumed that there is a single moving target in the target sensing area. In this case, reference channel delay domain information may be obtained by performing IDFT/IFFT calculation in a frequency domain dimension based on H2./H1 (a single OFDM symbol is used as an example). For example, a delay value in the first information reported by the terminal is 295.1 (ns) (a delay value of a strongest path or a path, whose strength exceeds the preset path strength threshold, corresponding to H2·/H1). It should be noted that the terminal may report a quantization result of actual delay information, or may report an index value corresponding to a path (a strongest path or a path whose strength exceeds the preset path strength threshold) that meets a condition after IDFT/IFFT is performed in frequency domain.

Similarly, reference channel Doppler domain information may be obtained by performing DFT/FFT calculation in a time domain dimension based on H2·/H1 (a single subcarrier is used as an example). For example, a Doppler frequency shift value in first information reported by the terminal is 293.3 (Hz) (a Doppler frequency shift value of a strongest path or a path, whose strength exceeds the preset path strength threshold, corresponding to H2·/H1).

Alternatively, delay-Doppler domain information may be obtained by performing a two-dimensional DFT/FFT operation based on H2·/H1, to obtain delay and Doppler measurement results in the first information. For example, a delay value and a Doppler frequency shift value in the first information reported by the terminal are 295.1 (ns) and 293.3 (Hz) (a delay value and a Doppler frequency shift value of a strongest path or a path, whose strength exceeds the preset path strength threshold, corresponding to H2·/H1).

Calculation of the angle information (a plurality of receive antennas) is similar. Based on H2·/H1 corresponding to different antennas, the angle information may be obtained by performing a DFT/FFT operation in an antenna dimension or by performing calculation by using a super-resolution algorithm such as MUSIC. For example, an angle of arrival in the first information reported by the terminal is-57.7° (an angle of arrival of a strongest path or a path, whose strength exceeds the preset path strength threshold, corresponding to H2·/H1). It may be understood that the angle information calculated herein is angle information in a local coordinate system of the receiver, and the angle information in the first information may be angle information in the local coordinate system, or may be converted into angle information in the global coordinate system.

Alternatively, delay-Doppler domain information may be obtained by performing a two-dimensional DFT/FFT operation based on H2·/H1, to obtain delay and Doppler measurement results in the first information. Alternatively, delay-Doppler-angle domain information is obtained by performing a three-dimensional DFT/FFT operation based on H2·/H1, to obtain delay, Doppler, and angle measurement results in the first information.

It should be noted that this example is provided for illustrative purposes, and a specific calculation method used is not limited.

It should be further noted that in this embodiment, the target signal may be the first channel information obtained based on the first signal, the second channel information obtained based on the second signal, or the quotient or a result of conjugate multiplication of the first channel information and the second channel information.

In conclusion, in the method in this embodiment of this application, based on a working principle of a bistatic radar, for a sensing scenario in which a transmit device and a receive device are not a same device, for example, sensing between base stations, uplink or downlink sensing, and sensing between terminals, a related measurement procedure is designed in the patent, includes a main signaling interaction procedure and definition of measurement feedback information, provides a method for overcoming impact of a non-ideal factor such as timing and frequency deviations caused by a difference between a transmit clock and a receive clock, including directly and respectively obtaining measurement results based on a reference channel signal and a monitoring channel signal and reporting the measurement results or reporting a measurement result difference value, or obtaining measurement results based on a quotient or conjugate multiplication of channel information of a reference channel signal and a monitoring channel signal and reporting the measurement results, and further includes definition and reporting of performance indicator information, to perform adaptive link adjustment, so as to improve accuracy of a sensing result.

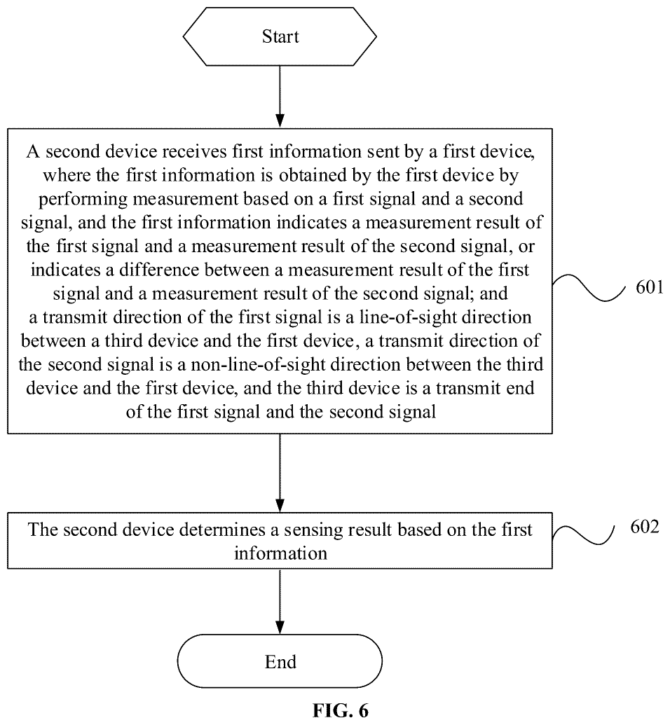

As shown in FIG. 6, a measurement method in an embodiment of this application includes the following steps.

Step 601: A second device receives first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal.

Step 602: The second device determines a sensing result based on the first information.

In this way, the second device can obtain the first information obtained through measurement by the first device, and then determine the sensing result based on the first information. The first information is obtained by the first device by performing measurement based on the first signal and the second signal after receiving the first signal, whose transmit direction is the LOS direction, and the second signal, whose transmit direction is the NLOS direction, that are sent by a third device, so that the determined sensing result has higher accuracy.

Optionally, the first information is associated with at least one of the following: delay information; distance information; Doppler information; velocity information; angle information; amplitude information; phase information; and spectrum information.

Optionally, the delay information includes at least one of the following:
a time of arrival of the first signal;
a time of arrival of the second signal; and
a time difference of arrival between the first signal and the second signal.

Optionally, the distance information includes at least one of the following:
a first distance, where the first distance is a distance between a target object and the first device;
a second distance, where the second distance is a distance between the target object and the third device;
a third distance, where the third distance is a sum of the first distance and the second distance; and
a fourth distance, where the fourth distance is a difference between the third distance and a fifth distance, and the fifth distance is a distance between the first device and the third device.

Optionally, the Doppler information includes at least one of the following:
a Doppler frequency shift of the first signal;
a Doppler frequency shift of the second signal; and
a Doppler frequency shift difference between the first signal and the second signal.

Optionally, the velocity information includes at least one of the following:
a moving velocity of the target object; and
a component of the moving velocity of the target object.

Optionally, the angle information includes at least one of the following:
an angle of arrival of the first signal;
an angle of arrival of the second signal;
an angle difference of arrival between the first signal and the second signal; and
a bistatic angle.

Optionally, the amplitude information includes at least one of the following:
an amplitude of the first signal;
an amplitude of the second signal; and
an amplitude difference between the first signal and the second signal.

Optionally, the phase information includes at least one of the following:
a phase of the first signal;
a phase of the second signal; and
a phase difference between the first signal and the second signal.

Optionally, the first information further includes performance indicator information, and the performance indicator information is used to adjust a sending configuration of the first signal and/or a sending configuration of the second signal.

Optionally, the performance indicator information includes at least one of the following:
a signal-to-noise ratio SNR of the first signal;
a signal-to-interference-plus-noise ratio SINR of the first signal;
an SNR of the second signal;
an SINR of the second signal;
an SNR obtained based on the SNR of the first signal and the SNR of the second signal;
an SINR obtained based on the SINR of the first signal and the SINR of the second signal;
power of a signal component associated with the target object;
an SNR of the signal component associated with the target object;
an SINR of the signal component associated with the target object;
a strength indicator of the first signal;
received power of the first signal;
received quality of the first signal;
a strength indicator of the second signal;
received power of the second signal; and
received quality of the second signal.

Optionally, the first signal or the second signal includes at least one of the following:
a reference signal;
a synchronization signal;
a sensing signal; and
a signal that carries communication data information.

Optionally, the first signal and the second signal meet at least one of the following:
a same time domain resource length;
a same time domain resource interval;
a same frequency domain resource length; and
a same frequency domain resource interval.

Optionally, the first signal and the second signal are frequency division multiplexing signals, time division multiplexing signals, or code division multiplexing signals.

Optionally, the method further includes:

The second device sends the first signal and the second signal before receiving the first information.

That is, the second device is a sending device of the first signal and the second signal.

Optionally, the method further includes:

The second device sends configuration information of the first signal and/or configuration information of the second signal before receiving the first information, where the configuration information includes at least one of the following:
a signal resource identifier;
waveform information;
a subcarrier spacing;
a guard interval;
frequency domain resource information;
time domain resource information;
signal power;
sequence information; and
a signal direction.

Optionally, the method further includes:

The second device sends measurement indication information before receiving the first information, where the measurement indication information includes at least one of the following:
a measurement signal indication;
a measurement quantity;
a reporting configuration; and
measurement auxiliary information.

Optionally, the method further includes:

The second device receives, before receiving the first information, second information sent by the first device, where the second information includes at least one of the following:
location information of the first device; and
channel state information of the first device and the third device.

Optionally, the method further includes:

The second device determines the transmit direction of the first signal based on the location information of the first device; and
the second device sends the first signal in the determined transmit direction of the first signal, or the second device notifies the third device of the transmit direction of the first signal.

Optionally, the method further includes:

The second device determines, based on the channel state information of the first device and the third device, whether the first device is to perform measurement based on the first signal and the second signal; and
when determining that the first device is to perform measurement based on the first signal and the second signal, the second device notifies the first device to perform the measurement.

It should be noted that the method in this embodiment of this application is implemented in cooperation with the foregoing measurement method performed by the first device. An implementation of the foregoing method embodiment is applicable to the method, and same technical effects can be achieved.

The measurement method provided in this embodiment of this application may be performed by a measurement apparatus. In an embodiment of this application, a measurement apparatus provided in an embodiment of this application is described by using an example in which the measurement apparatus performs the measurement method.

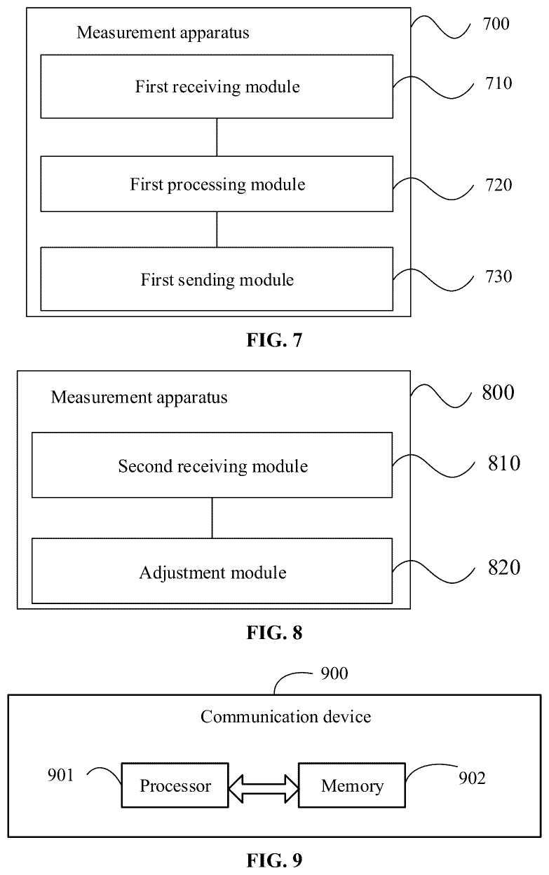

As shown in FIG. 7, a measurement apparatus 700 in an embodiment of this application includes:
a first receiving module 710, configured to receive a first signal and a second signal, where a transmit direction of the first signal is a line-of-sight direction between a third device and a first device, a transmit direction of the second signal is a non-line-of-sight direction between the third device and the first device, and the third device is a transmit end of the first signal and the second signal;
a first processing module 720, configured to perform measurement based on the first signal and the second signal, to obtain first information, where the first information indicates a measurement result of the first signal and a measurement result of the second signal, or indicates a difference between a measurement result of the first signal and a measurement result of the second signal; and
a first sending module 730, configured to send the first information to a second device.

Optionally, the first information is associated with at least one of the following:
delay information; distance information; Doppler information; velocity information; angle information; amplitude information; phase information; and spectrum information.

Optionally, the delay information includes at least one of the following:
a time of arrival of the first signal;
a time of arrival of the second signal; and
a time difference of arrival between the first signal and the second signal.

Optionally, the distance information includes at least one of the following:
a first distance, where the first distance is a distance between a target object and the first device;
a second distance, where the second distance is a distance between the target object and the third device;
a third distance, where the third distance is a sum of the first distance and the second distance; and
a fourth distance, where the fourth distance is a difference between the third distance and a fifth distance, and the fifth distance is a distance between the first device and the third device.

Optionally, the Doppler information includes at least one of the following:
a Doppler frequency shift of the first signal;
a Doppler frequency shift of the second signal; and
a Doppler frequency shift difference between the first signal and the second signal.

Optionally, the velocity information includes at least one of the following:
a moving velocity of the target object; and
a component of the moving velocity of the target object.

Optionally, the angle information includes at least one of the following:
an angle of arrival of the first signal;
an angle of arrival of the second signal;
an angle difference of arrival between the first signal and the second signal; and
a bistatic angle.

Optionally, the amplitude information includes at least one of the following:
an amplitude of the first signal;
an amplitude of the second signal; and
an amplitude difference between the first signal and the second signal.

Optionally, the phase information includes at least one of the following:
a phase of the first signal;
a phase of the second signal; and
a phase difference between the first signal and the second signal.

Optionally, the first information further includes performance indicator information, and the performance indicator information is used to adjust a sending configuration of the first signal and/or a sending configuration of the second signal.

Optionally, the performance indicator information includes at least one of the following:
a signal-to-noise ratio SNR of the first signal;
a signal-to-interference-plus-noise ratio SINR of the first signal;
an SNR of the second signal;
an SINR of the second signal;
an SNR obtained based on the SNR of the first signal and the SNR of the second signal;
an SINR obtained based on the SINR of the first signal and the SINR of the second signal;
power of a signal component associated with the target object;
an SNR of the signal component associated with the target object;
an SINR of the signal component associated with the target object;
a strength indicator of the first signal;
received power of the first signal;
received quality of the first signal;
a strength indicator of the second signal;
received power of the second signal; and
received quality of the second signal.

Optionally, the first signal or the second signal includes at least one of the following:
a reference signal;
a synchronization signal;
a sensing signal; and
a signal that carries communication data information.

Optionally, the first processing module includes:
a first processing unit, configured to obtain first channel information based on the first signal;
a second processing unit, configured to obtain second channel information based on the second signal; and
a third processing unit, configured to obtain the first information based on the first channel information and the second channel information.

Optionally, the apparatus further includes:
a first obtaining module, configured to obtain configuration information of the first signal and/or configuration information of the second signal before the first signal and the second signal are received, where the configuration information includes at least one of the following:
a signal resource identifier;
waveform information;
a subcarrier spacing;
a guard interval;
frequency domain resource information;
time domain resource information;
signal power;
sequence information; and
a signal direction.

Optionally, the first signal and the second signal meet at least one of the following:
a same time domain resource length;
a same time domain resource interval;
a same frequency domain resource length; and
a same frequency domain resource interval.

Optionally, the first signal and the second signal are frequency division multiplexing signals, time division multiplexing signals, or code division multiplexing signals.

Optionally, the apparatus further includes:
a second obtaining module, configured to obtain measurement indication information before measurement is performed, where the measurement indication information includes at least one of the following:
a measurement signal indication;
a measurement quantity;
a reporting configuration; and
measurement auxiliary information.

Optionally, the apparatus further includes:
a third obtaining module, configured to send second information before the measurement indication information is obtained, where the second information includes at least one of the following:
location information of the first device; and
channel state information of the first device and the third device.

After receiving the first signal, whose transmit direction is the LOS direction, and the second signal, whose transmit direction is the NLOS direction, that are sent by the third device, the apparatus can perform measurement based on the first signal and the second signal, to obtain the first information indicating the measurement result of the first signal and the measurement result of the second signal or the difference between the measurement result of the first signal and the measurement result of the second signal, and send the first information to the second device, so that the second device can determine a sensing result based on the first information, thereby improving accuracy of the sensing result.

The measurement apparatus in this embodiment of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The measurement apparatus provided in this embodiment of this application can implement the processes implemented in the method embodiment in FIG. 4, and achieve same technical effects. To avoid repetition, details are not described herein again.

As shown in FIG. 8, a measurement apparatus 800 in an embodiment of this application includes:
a second receiving module 810, configured to receive first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal; and
a determining module 820, configured to determine a sensing result based on the first information. Optionally, the first information is associated with at least one of the following:
delay information; distance information; Doppler information; velocity information; angle information; amplitude information; phase information; and spectrum information.

Optionally, the delay information includes at least one of the following:
a time of arrival of the first signal;
a time of arrival of the second signal; and
a time difference of arrival between the first signal and the second signal.

Optionally, the distance information includes at least one of the following:
a first distance, where the first distance is a distance between a target object and the first device;
a second distance, where the second distance is a distance between the target object and the third device;
a third distance, where the third distance is a sum of the first distance and the second distance; and
a fourth distance, where the fourth distance is a difference between the third distance and a fifth distance, and the fifth distance is a distance between the first device and the third device.

Optionally, the Doppler information includes at least one of the following:
a Doppler frequency shift of the first signal;
a Doppler frequency shift of the second signal; and
a Doppler frequency shift difference between the first signal and the second signal.

Optionally, the velocity information includes at least one of the following:
a moving velocity of the target object; and
a component of the moving velocity of the target object.

Optionally, the angle information includes at least one of the following:
an angle of arrival of the first signal;
an angle of arrival of the second signal;
an angle difference of arrival between the first signal and the second signal; and
a bistatic angle.

Optionally, the amplitude information includes at least one of the following:
an amplitude of the first signal;
an amplitude of the second signal; and
an amplitude difference between the first signal and the second signal.

Optionally, the phase information includes at least one of the following:
a phase of the first signal;
a phase of the second signal; and
a phase difference between the first signal and the second signal.

Optionally, the first information further includes performance indicator information, and the performance indicator information is used to adjust a sending configuration of the first signal and/or a sending configuration of the second signal.

Optionally, the performance indicator information includes at least one of the following:
a signal-to-noise ratio SNR of the first signal;
a signal-to-interference-plus-noise ratio SINR of the first signal;
an SNR of the second signal;
an SINR of the second signal;
an SNR obtained based on the SNR of the first signal and the SNR of the second signal;
an SINR obtained based on the SINR of the first signal and the SINR of the second signal;
power of a signal component associated with the target object;
an SNR of the signal component associated with the target object;
an SINR of the signal component associated with the target object;
a strength indicator of the first signal;
received power of the first signal;
received quality of the first signal;
a strength indicator of the second signal;
received power of the second signal; and
received quality of the second signal.

Optionally, the first signal or the second signal includes at least one of the following:
a reference signal;
a synchronization signal;
a sensing signal; and
a signal that carries communication data information.

Optionally, the first signal and the second signal meet at least one of the following:
a same time domain resource length;
a same time domain resource interval;
a same frequency domain resource length; and
a same frequency domain resource interval.

Optionally, the first signal and the second signal are frequency division multiplexing signals, time division multiplexing signals, or code division multiplexing signals.

Optionally, the apparatus further includes:
a second sending module, configured to send the first signal and the second signal before the first information is received.

Optionally, the apparatus further includes:
a third sending module, configured to send configuration information of the first signal and/or configuration information of the second signal before the first information is received, where the configuration information includes at least one of the following:
a signal resource identifier;
waveform information;
a subcarrier spacing;
a guard interval;
frequency domain resource information;
time domain resource information;
signal power;
sequence information; and
a signal direction.

Optionally, the apparatus further includes:
a fourth sending module, configured to send measurement indication information before the first information is received, where the measurement indication information includes at least one of the following:
a measurement signal indication;
a measurement quantity;
a reporting configuration; and
measurement auxiliary information.

Optionally, the apparatus further includes:
a third receiving module, configured to receive, before the first information is received, second information sent by the first device, where the second information includes at least one of the following:
location information of the first device; and
channel state information of the first device and the third device.

Optionally, the apparatus further includes:
a second processing module, configured to:
determine the transmit direction of the first signal based on the location information of the first device; and
send the first signal in the determined transmit direction of the first signal, or the second device notifies the third device of the transmit direction of the first signal.

Optionally, the apparatus further includes a third processing module, configured to: determine, based on the channel state information of the first device and the third device, whether the first device is to perform measurement based on the first signal and the second signal; and
when determining that the first device is to perform measurement based on the first signal and the second signal, notify the first device to perform the measurement.

The apparatus can obtain the first information obtained through measurement by the first device, and then determine the sensing result based on the first information, thereby improving accuracy of the sensing result. The first information is obtained by the first device by performing measurement based on the first signal and the second signal after receiving the first signal, whose transmit direction is the LOS direction, and the second signal, whose transmit direction is the NLOS direction, that are sent by the third device, so that the determined sensing result has higher accuracy.

The measurement apparatus in this embodiment of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The measurement apparatus provided in this embodiment of this application can implement the processes implemented in the method embodiment in FIG. 6, and achieve same technical effects. To avoid repetition, details are not described herein again.

Optionally, as shown in FIG. 9, an embodiment of this application further provides a communication device 900, including a processor 901 and a memory 902. The memory 902 stores a program or instructions capable of being run on the processor 901. For example, when the communication device 900 is a first device, and when the program or the instructions are executed by the processor 901, the steps in the embodiment of the measurement method performed by the first device are implemented, and same technical effects can be achieved. When the communication device 900 is a second device, and when the program or the instructions are executed by the processor 901, the steps in the embodiment of the measurement method performed by the second device are implemented, and same technical effects can be achieved. To avoid repetition, details are not described herein again.

An embodiment of this application further provides a terminal, including a processor and a communication interface.

When the terminal is a first device, the communication interface is configured to receive a first signal and a second signal, where a transmit direction of the first signal is a line-of-sight direction between a third device and the first device, a transmit direction of the second signal is a non-line-of-sight direction between the third device and the first device, and the third device is a transmit end of the first signal and the second signal. The processor is configured to perform measurement based on the first signal and the second signal, to obtain first information, where the first information indicates a measurement result of the first signal and a measurement result of the second signal, or indicates a difference between a measurement result of the first signal and a measurement result of the second signal. The communication interface is further configured to send the first information to a second device.

When the terminal is a second device, the communication interface is configured to receive first information sent by a first device, where
the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal.

The processor is configured to adjust the measurement result of the second signal based on the measurement result of the first signal.

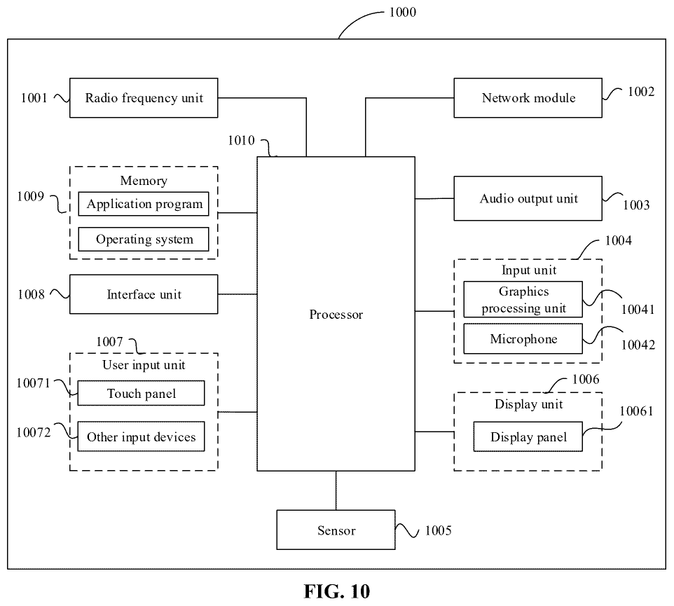

The terminal embodiment corresponds to the foregoing terminal-side method embodiment. Each implementation process and implementation of the foregoing method embodiment may be applied to the terminal embodiment, and same technical effects can be achieved. Specifically, FIG. 10 is a schematic diagram of a hardware structure of a terminal for implementing an embodiment of this application.

The terminal 1000 includes but is not limited to at least some components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art may understand that the terminal 1000 may further include a power supply (for example, a battery) that supplies power to each component. The power supply may be logically connected to the processor 1010 by using a power management system, to implement functions such as charging management, discharging management, and power consumption management through the power management system. The structure of the terminal shown in FIG. 10 does not constitute a limitation on the terminal. The terminal may include more or fewer components than those shown in the figure, or combine some components, or have different component arrangements. Details are not described herein again.

It should be understood that in this embodiment of this application, the input unit 1004 may include a graphics processing unit (GPU) 10041 and a microphone 10042. The graphics processing unit 10041 processes image data of a still picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1001 may transmit the downlink data to the processor 1010 for processing. In addition, the radio frequency unit 1001 may send uplink data to the network-side device. Generally, the radio frequency unit 1001 includes but is not limited to an antenna, an amplifier, a transceiver, a coupler, a low-noise amplifier, a duplexer, and the like.

The memory 1009 may be configured to store a software program or instructions and various types of data. The memory 1009 may mainly include a first storage area for storing a program or instructions and a second storage area for storing data. The first storage area may store an operating system, an application program or instructions required by at least one function (for example, a sound play function or an image play function), and the like. In addition, the memory 1009 may include a volatile memory or a non-volatile memory, or the memory 1009 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1009 in this embodiment of this application includes but is not limited to these memories and any other suitable type of memory.

The processor 1010 may include one or more processing units. Optionally, the processor 1010 integrates an application processor and a modem processor. The application processor mainly processes operations related to an operating system, a user interface, an application program, and the like. The modem processor, for example, a baseband processor, mainly processes a wireless communication signal. It may be understood that the modem processor may not be integrated into the processor 1010.

An embodiment of this application further provides a network-side device, including a processor and a communication interface.

When the network-side device is a first device, the communication interface is configured to receive a first signal and a second signal, where a transmit direction of the first signal is a line-of-sight direction between a third device and the first device, a transmit direction of the second signal is a non-line-of-sight direction between the third device and the first device, and the third device is a transmit end of the first signal and the second signal. The processor is configured to perform measurement based on the first signal and the second signal, to obtain first information, where the first information indicates a measurement result of the first signal and a measurement result of the second signal, or indicates a difference between a measurement result of the first signal and a measurement result of the second signal. The communication interface is further configured to send the first information to a second device.

When the network-side device is a second device, the communication interface is configured to receive first information sent by a first device, where the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal.

The processor is configured to adjust the measurement result of the second signal based on the measurement result of the first signal.

The network-side device embodiment corresponds to the foregoing network-side device method embodiment. Each implementation process and implementation of the foregoing method embodiment may be applied to the network-side device embodiment, and same technical effects can be achieved.

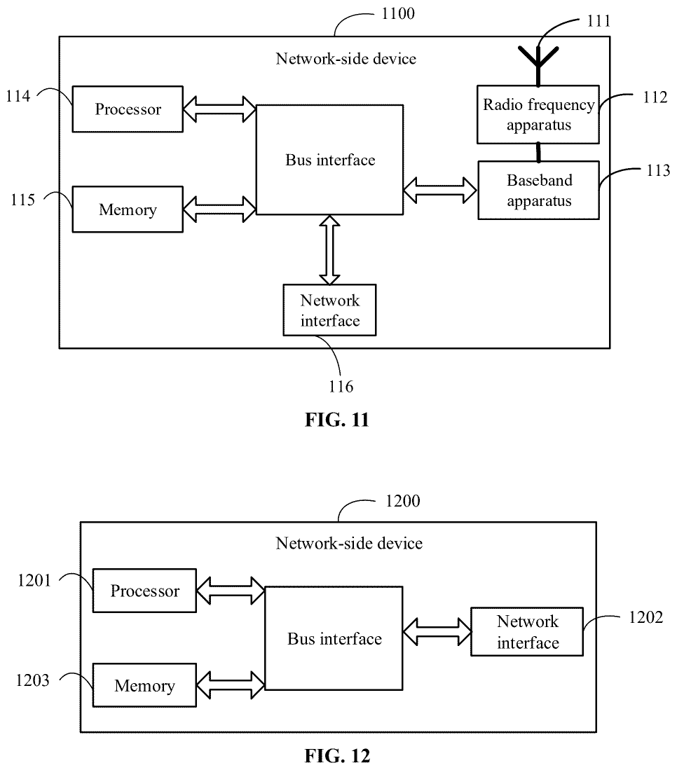

Specifically, an embodiment of this application further provides a network-side device. As shown in FIG. 11, the network-side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends processed information to the radio frequency apparatus 112. After processing the received information, the radio frequency apparatus 112 sends processed information through the antenna 111.

The method performed by the network-side device in the foregoing embodiment may be implemented in the baseband apparatus 113. The baseband apparatus 113 includes a baseband processor.

For example, the baseband apparatus 113 may include at least one baseband board. A plurality of chips are disposed on the baseband board. As shown in FIG. 11, one of the chips is, for example, the baseband processor, and is connected to the memory 115 by using a bus interface, to invoke a program in the memory 115 to perform the operation of the network device shown in the foregoing method embodiment.

The network-side device may further include a network interface 116. For example, the interface is a common public radio interface (CPRI).

Specifically, the network-side device 1100 in this embodiment of this application further includes instructions or a program stored in the memory 115 and capable of being run on the processor 114. The processor 114 invokes the instructions or the program in the memory 115 to perform the method performed by the modules shown in FIG. 7 or FIG. 8, and same technical effects are achieved. To avoid repetition, details are not described herein again.

Specifically, an embodiment of this application further provides a network-side device. As shown in FIG. 12, the network-side device 1200 includes a processor 1201, a network interface 1202, and a memory 1203. The network interface 1202 is, for example, a common public radio interface (CPRI).

Specifically, the network-side device 1200 in this embodiment of this application further includes instructions or a program stored in the memory 1203 and capable of being run on the processor 1201. The processor 1201 invokes the instructions or the program in the memory 1203 to perform the method performed by the modules shown in FIG. 7 or FIG. 8, and same technical effects are achieved. To avoid repetition, details are not described herein again.

An embodiment of this application further provides a readable storage medium. The readable storage medium stores a program or instructions. When the program or the instructions are executed by a processor, the processes in the foregoing measurement method embodiments are implemented, and same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing measurement method embodiments, and same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing measurement method embodiments, and same technical effects can be achieved. To avoid repetition, details are not described herein again.

An embodiment of this application further provides a measurement system, including a first device and a second device. The first device may be configured to perform the steps of the measurement method performed by the first device, and the second device may be configured to perform the steps of the measurement method performed by the second device.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the related technology can be embodied in a form of a computer software product. The computer software product is stored in a storage medium (for example, a ROM/RAM, a magnetic disk, or an optical disc), and includes several instructions for enabling a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. A measurement method, comprising:
receiving, by a first device, a first signal and a second signal, wherein a transmit direction of the first signal is a line-of-sight direction between a third device and the first device, a transmit direction of the second signal is a non-line-of-sight direction between the third device and the first device, and the third device is a transmit end of the first signal and the second signal;
performing, by the first device, measurement based on the first signal and the second signal, to obtain first information, wherein the first information indicates a measurement result of the first signal and a measurement result of the second signal, or indicates a difference between a measurement result of the first signal and a measurement result of the second signal; and
sending, by the first device, the first information to a second device.

2. The method according to claim 1, wherein the first information is associated with at least one of the following:
delay information;
distance information;
Doppler information;
velocity information;
angle information;
amplitude information;
phase information; or
spectrum information.

3. The method according to claim 2, wherein the delay information comprises at least one of the following:
a time of arrival of the first signal;
a time of arrival of the second signal; or
a time difference of arrival between the first signal and the second signal.

4. The method according to claim 2, wherein the distance information comprises at least one of the following:
a first distance, wherein the first distance is a distance between a target object and the first device;
a second distance, wherein the second distance is a distance between the target object and the third device;
a third distance, wherein the third distance is a sum of the first distance and the second distance; or a fourth distance, wherein the fourth distance is a difference between the third distance and a fifth distance, and the fifth distance is a distance between the first device and the third device.

5. The method according to claim 2, wherein the Doppler information comprises at least one of the following:
a Doppler frequency shift of the first signal;
a Doppler frequency shift of the second signal; or
a Doppler frequency shift difference between the first signal and the second signal.

6. The method according to claim 2, wherein the velocity information comprises at least one of the following:
a moving velocity of the target object; or
a component of the moving velocity of the target object; and/or
wherein the angle information comprises at least one of the following:
an angle of arrival of the first signal;
an angle of arrival of the second signal;
an angle difference of arrival between the first signal and the second signal; or
a bistatic angle.

7. The method according to claim 2, wherein the amplitude information comprises at least one of the following:
an amplitude of the first signal;
an amplitude of the second signal; or
an amplitude difference between the first signal and the second signal; and/or
wherein the phase information comprises at least one of the following:
a phase of the first signal;
a phase of the second signal; or
a phase difference between the first signal and the second signal.

8. The method according to claim 1, wherein the first information further comprises performance indicator information, and the performance indicator information is used to adjust a sending configuration of the first signal and/or a sending configuration of the second signal;
wherein the performance indicator information comprises at least one of the following:
a signal-to-noise ratio (SNR) of the first signal;
a signal-to-interference-plus-noise ratio (SINR) of the first signal;
an SNR of the second signal;
an SINR of the second signal;
an SNR obtained based on the SNR of the first signal and the SNR of the second signal;
an SINR obtained based on the SINR of the first signal and the SINR of the second signal;
power of a signal component associated with the target object;
an SNR of the signal component associated with the target object;
an SINR of the signal component associated with the target object;
a strength indicator of the first signal;
received power of the first signal;
received quality of the first signal;
a strength indicator of the second signal;
received power of the second signal; or
received quality of the second signal.

9. The method according to claim 1, wherein the first signal or the second signal comprises at least one of the following:
a reference signal;
a synchronization signal;
a sensing signal; or
a signal that carries communication data information.

10. The method according to claim 1, wherein the performing, by the first device, measurement based on the first signal and the second signal, to obtain first information comprises:
obtaining, by the first device, first channel information based on the first signal;
obtaining, by the first device, second channel information based on the second signal; and
obtaining, by the first device, the first information based on the first channel information and the second channel information.

11. The method according to claim 1, further comprising:
obtaining, by the first device, configuration information of the first signal and/or configuration information of the second signal before receiving the first signal and the second signal, wherein the configuration information comprises at least one of the following:
a signal resource identifier;
waveform information;
a subcarrier spacing;
a guard interval;
frequency domain resource information;
time domain resource information;
signal power;
sequence information; or
a signal direction.

12. The method according to claim 1, wherein the first signal and the second signal meet at least one of the following:
a same time domain resource length;
a same time domain resource interval;
a same frequency domain resource length; or
a same frequency domain resource interval; and/or
wherein the first signal and the second signal are frequency division multiplexing signals, time division multiplexing signals, or code division multiplexing signals.

13. The method according to claim 1, further comprising:
obtaining, by the first device, measurement indication information before performing measurement, wherein the measurement indication information comprises at least one of the following:
a measurement signal indication;
a measurement quantity;
a reporting configuration; or
measurement auxiliary information; and/or
the method further comprising:
sending, by the first device, second information before obtaining the measurement indication information, wherein the second information comprises at least one of the following:
location information of the first device; or
channel state information of the first device and the third device.

14. A measurement method, comprising:
receiving, by a second device, first information sent by a first device, wherein the first information is obtained by the first device by performing measurement based on a first signal and a second signal, and the first information indicates a measurement result of the first signal and a measurement result of the second signal, or indicates a difference between a measurement result of the first signal and a measurement result of the second signal; and a transmit direction of the first signal is a line-of-sight direction between a third device and the first device, a transmit direction of the second signal is a non-line-of-sight direction between the third device and the first device, and the third device is a transmit end of the first signal and the second signal; and
determining, by the second device, a sensing result based on the first information.

15. The method according to claim 14, wherein the first information is associated with at least one of the following:
delay information;
distance information;
Doppler information;
velocity information;
angle information;
amplitude information;
phase information; or
spectrum information.

16. The method according to claim 14, further comprising:
sending, by the second device, the first signal and the second signal before receiving the first information; and/or
the method further comprising:
sending, by the second device, configuration information of the first signal and/or configuration information of the second signal before receiving the first information, wherein the configuration information comprises at least one of the following:
a signal resource identifier;
waveform information;
a subcarrier spacing;
a guard interval;
frequency domain resource information;
time domain resource information;
signal power;
sequence information; or
a signal direction; and/or
the method further comprising:
sending, by the second device, measurement indication information before receiving the first information, wherein the measurement indication information comprises at least one of the following:
a measurement signal indication;
a measurement quantity;
a reporting configuration; or
measurement auxiliary information.

17. The method according to claim 14, further comprising:
receiving, by the second device before receiving the first information, second information sent by the first device, wherein the second information comprises at least one of the following:
location information of the first device; or
channel state information of the first device and the third device.

18. The method according to claim 17, further comprising:
determining, by the second device, the transmit direction of the first signal based on the location information of the first device; and
sending, by the second device, the first signal in the determined transmit direction of the first signal, or notifying, by the second device, the third device of the transmit direction of the first signal; or,
the method further comprising:
determining, by the second device based on the channel state information of the first device and the third device, whether the first device is to perform measurement based on the first signal and the second signal; and
when determining that the first device is to perform measurement based on the first signal and the second signal, notifying, by the second device, the first device to perform the measurement.

19. A communication device, comprising a processor and a memory, wherein the memory stores a program or instructions capable of being run on the processor, wherein the program or the instructions, when executed by the processor, cause the processor to perform:
receiving a first signal and a second signal, wherein a transmit direction of the first signal is a line-of-sight direction between a third device and the first device, a transmit direction of the second signal is a non-line-of-sight direction between the third device and the first device, and the third device is a transmit end of the first signal and the second signal;
performing measurement based on the first signal and the second signal, to obtain first information, wherein the first information indicates a measurement result of the first signal and a measurement result of the second signal, or indicates a difference between a measurement result of the first signal and a measurement result of the second signal; and
sending the first information to a second device.

20. A communication device, comprising a processor and a memory, wherein the memory stores a program or instructions capable of being run on the processor, and when the program or the instructions are executed by the processor, the steps of the measurement method according to claim 14 are implemented.
